(19) United States
(12) Patent Application Publication
(10) Pub. No.: US 2015/0042425 A1
(43) Pub. Date: Feb. 12, 2015

(54) CONTACT MECHANISM AND ELECTROMAGNETIC RELAY

(71) Applicant: OMRON CORPORATION, Kyoto-Shi (JP)

(72) Inventors: Toshifumi Sumino, Katano-shi (JP); Masaaki Yamamoto, Ibaraki-shi (JP); Tatsuro Kato, Kusatsu-shi (JP); Kazuki Tsujikawa, Koshi-shi (JP); Kazuya Murakami, Kusatsu-shi (JP); Harumichi Kitaguchi, Moriyama-shi (JP); Shinya Matsuo, Yamaga-shi (JP); Daisuke Narimatsu, Yamaga-shi (JP)

(73) Assignee: OMRON CORPORATION, Kyoto-Shi (JP)

(21) Appl. No.: 14/447,047

(22) Filed: Jul. 30, 2014

(30) Foreign Application Priority Data
Aug. 8, 2013 (JP) 2013-166950

(51) Int. Cl. H01H 50/64

(52) U.S. Cl. CPC H01H 50/643
USPC 335/189

(57) ABSTRACT

A contact mechanism with long contact lifetime comprises a base; a movable touch piece that comprises a movable contact and stands in the base; and a fixed touch piece that comprises a fixed contact and stands in the base, wherein the movable contact is opposed to the fixed contact and configured to come into contact with and separate from the fixed contact, an operation member configured to move reciprocally in a horizontal direction is configured to press and release an upper end edge of the movable touch piece, and the movable touch piece is configured to turn to cause the movable contact to come into contact with and separate from the fixed contact, and the movable contact is fixed to a turning tongue piece that is formed cut out by providing a curved cutout groove in the movable touch piece.

### CROSS-REFERENCE TO RELATED APPLICATION

This application claims the benefit of priority from Japanese Patent Application No. 2013-166950, filed on 8 Aug. 2013, the entire contents of which is incorporated herein by reference for all purposes.

### BACKGROUND

The present invention relates to a contact mechanism, for example, a contact mechanism assembled in an electromagnetic relay.

Japanese Unexamined Patent Publication No. 2004-164948 discloses an electromagnetic relay in which a conventional contact mechanism is assembled. In a conventional contact mechanism, a movable touch piece and a fixed touch piece are provided in parallel in a base, a card is reciprocally moved in a horizontal direction by turning a movable iron piece based on excitation and demagnetization of a coil block placed on the base, the movable touch piece is elastically deformed to cause a movable contact provided in the movable touch piece to come into contact with and separate from a fixed contact provided in the fixed touch piece. In a configuration of the electromagnetic relay, card receiving portions located at upper and lower portions are formed by bending leading end portions of the movable touch piece, and a leading end portion of the card abuts on inner surfaces of the card receiving portions.

However, in the contact mechanism assembled in the electromagnetic relay, when card 70 presses an upper end edge of movable touch piece 52 to turn movable contact 51 as illustrated in FIG. 7A, movable contact 51 abuts on fixed contact 42 (FIG. 7B). When movable touch piece 52 is further pushed in, movable contact 51 wipes on fixed contact 42, and fixed touch piece 52 is bent rearward (FIG. 7C). Although movable contact 51 seems to be in total contact with fixed contact 42 at a position where movable contact 51 abuts on fixed contact 42, actually only a lower end edge of movable contact 51 is in one-sided contact with fixed contact 42 at a pinpoint. As a result, in the case that the contact mechanism is used in an electromagnetic relay through which a large amount of current is passed, the contacts are possibly abraded at an early stage resulting in shortening of contact lifetimes.

On the other hand, as illustrated in FIG. 7D, when a pressing force on card 70 is released, movable touch piece 52 is returned by a force (such as a self-spring force), and movable contact 51 moves in a tensile direction because movable contact 51 is displaced while wiping on fixed contact 42. Therefore, in the case that welding of the contacts is generated, unfortunately a large tensile opening force is required to open the contacts, and since fixed touch piece 43 is also bent on a side of movable touch piece 52, an even larger tensile opening force is required.

A purpose of the present invention is to provide a long-contact-lifetime contact mechanism in which a large force is not required to open the contact at the time of return.

### SUMMARY

In accordance with an embodiment of the present invention, there is provided a contact mechanism in which a base, a movable touch piece that comprises a movable contact and stands in the base, and a fixed touch piece that comprises a fixed contact and stands in the base, wherein the movable contact is opposed to the fixed contact and configured to come into contact with and separate from the fixed contact, an operation member configured to move reciprocally in a horizontal direction is configured to press and release an upper end edge of the movable touch piece, and the movable touch piece is configured to turn to cause the movable contact to come into contact with and separate from the fixed contact, and the movable contact is fixed to a turning tongue piece that is formed by providing a cutout groove in the movable touch piece.

### BRIEF DESCRIPTION OF THE DRAWINGS

FIGS. 1A and 1B are schematic perspective views illustrating an electromagnetic relay in which a contact mechanism according to an embodiment of the present invention is assembled when the electromagnetic relay is viewed from different angles;

FIG. 2 is an exploded perspective view of the electromagnetic relay in FIG. 1A;

FIG. 3 is an exploded perspective view of the electromagnetic relay in FIG. 1B;

FIG. 4 is an enlarged front view of a movable contact terminal in FIGS. 2 and 3;

FIGS. 5A and 5B are sectional views illustrating the electromagnetic relay in FIGS. 1A and 1B before and after an operation;

FIGS. 6A to 6F are schematic views illustrating the electromagnetic relay in FIGS. 5A and 5B before and after the operation; and

FIGS. 7A to 7F are schematic views illustrating a conventional electromagnetic relay before and after the operation.

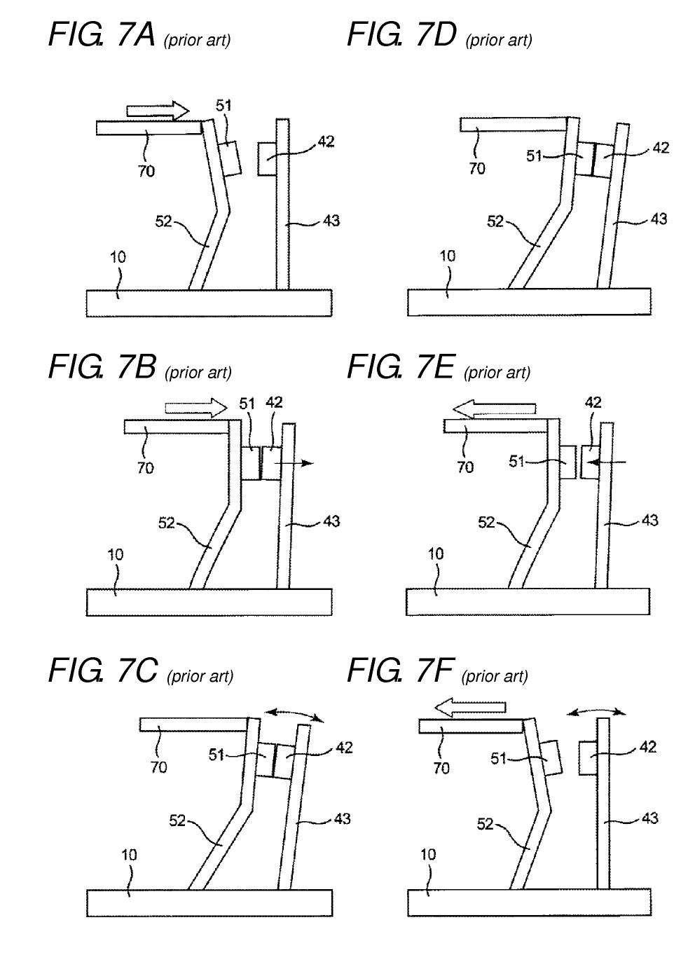

### DETAILED DESCRIPTION

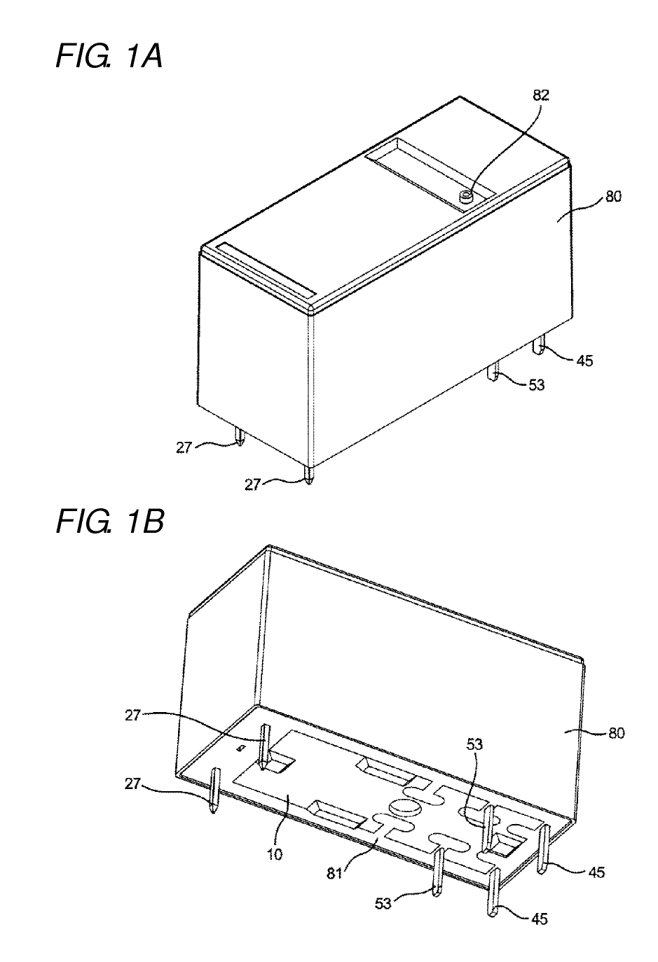

A self-holding electromagnetic relay in which a contact mechanism according to an embodiment of the present invention is applied will be described with reference to FIGS. 1A to 6F. In the following description, a term (such as terms including “up”, “down”, “side”, and “end”) indicating a specific direction or position is used as needed basis. However, the use of the term is aimed only at easy understanding of the present invention with reference to the accompanying drawings, but the technical scope of the present invention is not restricted to the meaning of the term.

The embodiment is provided only as an example, and the present invention is not limited to the embodiment.

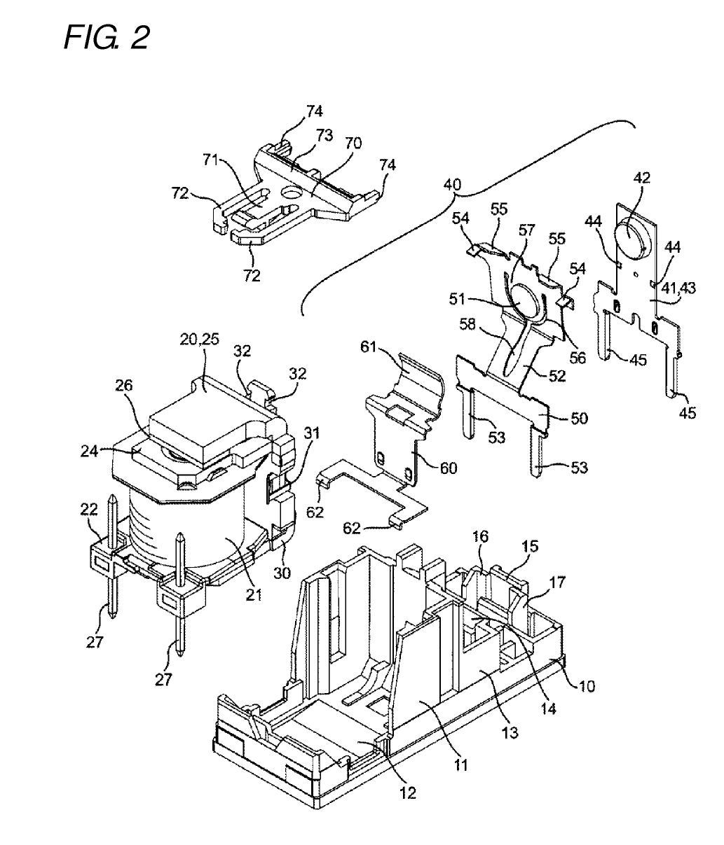

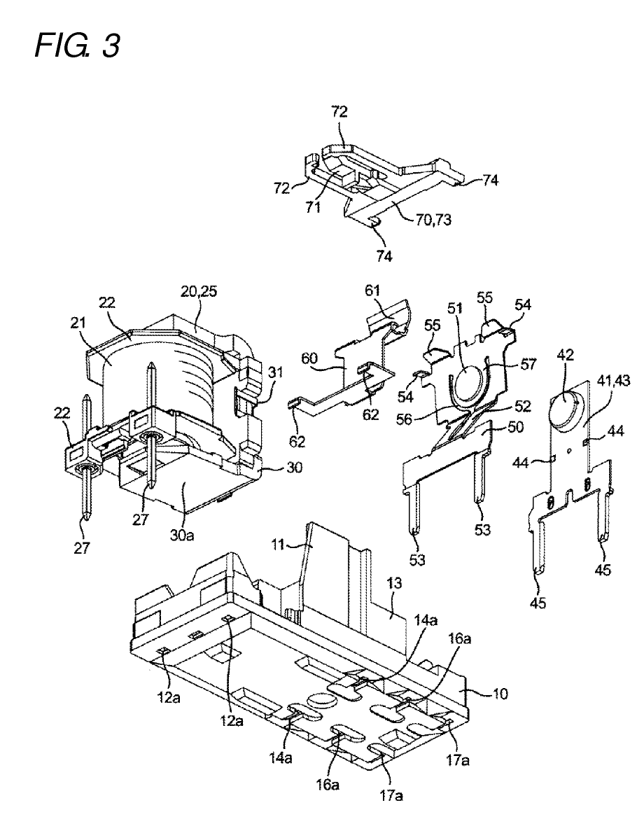

As illustrated in FIGS. 2 and 3, the electromagnetic relay of the embodiment includes base 10, electromagnetic block 20, movable iron piece 30, contact mechanism 40, card 70, and box type cover 80.

In base 10, as illustrated in FIG. 2, insulating wall 11 having a gate shape in planar view is provided to stand in a center of an upper surface to form storage portion 12, and coil terminal holes 12a (FIG. 3) are made in a bottom surface of storage portion 12.

In base 10, fitting wall 13 having a gate shape in planar view is integrally molded so as to be adjacent to an outside surface of insulating wall 11, thereby forming fitting recess 14. A pair of latching holes 14a are made in the bottom surface of fitting recess 14.

In base 10, position restriction rib 15 is projected at an upper edge located on a side opposite to insulating wall 11, and a pair of L-shape position restriction ribs 16 and 17 are projected at positions opposed to each other at edges on both sides of position restriction rib 15. Therefore, base 10 has a structure in which fixed contact terminal 41 can be fixed by press-fitting. Terminal holes 16a and 16a are made in the bottom surface located between fitting wall 13 and L-shape position restriction ribs 16 and 17, and terminal holes 17a and 17a are made in the bottom surface located between position restriction rib 15 and L-shape position restriction ribs 16 and 17.

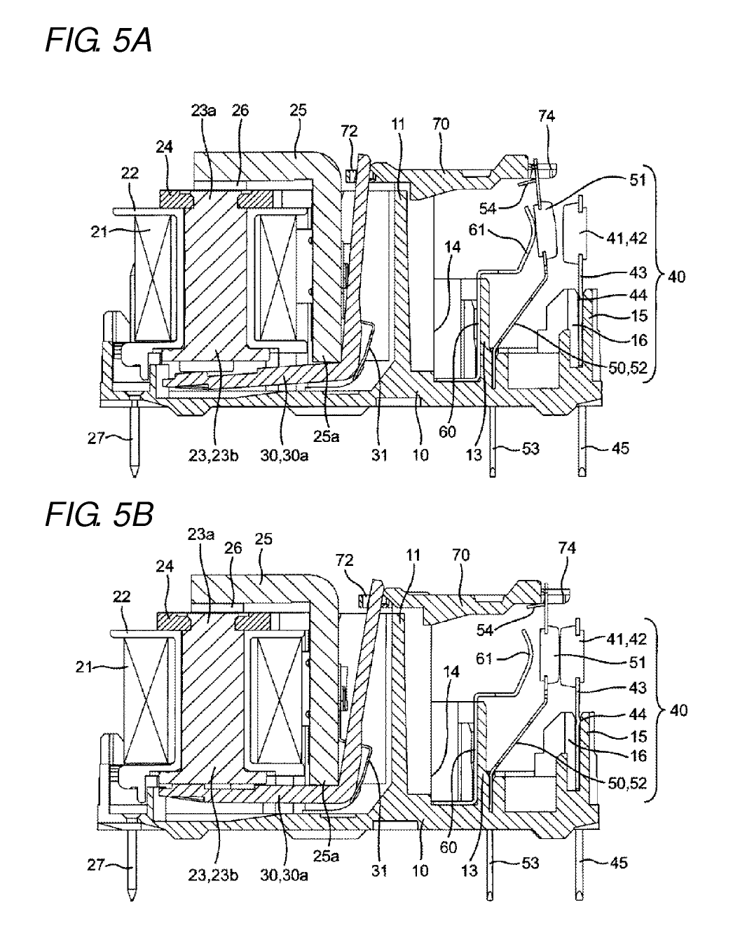

In electromagnetic block 20, as illustrated in FIGS. 5A and 5B, iron core 23 having a T-shape in section is inserted in spool 22 around which coil 21 is wound, one projecting end portion 23a is fixed to auxiliary yoke 24 by caulking, permanent magnet 26 is sandwiched between a leading end surface of one end portion 23a and a horizontal portion of yoke 25 having a substantial L-shape in section, and a second projecting end portion of iron core 23 constitutes magnetic pole portion 23b. Coil terminal 27 is press-fitted in spool 22, and leads of coil 21 are soldered to coil terminal 27 while tied up. Auxiliary yoke 24 abuts on a side surface of yoke 25 to form a magnetic circuit together with yoke 25 and permanent magnet 26 at the time of return such that movable iron piece 30 does not malfunction due to an external vibration.

Movable iron piece 30 is made of a magnetic material bent into a substantial L-shape. Movable iron piece 30 is turnably supported with lower end 25a of yoke 25 as fulcrum by hinge spring 31 attached to the edges on both the sides of a perpendicular portion of yoke 25. Therefore, horizontal end portion 30a of movable iron piece 30 is opposed to magnetic pole portion 23b of iron core 23 so as to be able to come into contact with and separate from magnetic pole portion 23b. Notches 32 are provided in upper end edge of the perpendicular portion of movable iron piece 30 (FIG. 2).

Contact mechanism 40 includes fixed contact terminal 41 to which fixed contact 42 is fixed by caulking, movable contact terminal 50 to which movable contact 51 is fixed by caulking, and elastic touch piece 60 that comes into press contact with movable contact 51 at the time of return.

In fixed contact terminal 41, aligning projections 44 are formed to protrude at the edges on both the sides of fixed touch piece 43 in which fixed contact 42 is provided. A pair of terminals 45 and 45 extending downward from fixed touch piece 43 is inserted in terminal holes 17a and 17a of base 10 (FIG. 3), and fixed touch piece 43 is press-fitted between position restriction rib 15 and L-shape position restriction ribs 16 and 17 (FIG. 2). This enables fixed touch piece 43 to be elastically deformed using aligning projections 44 as the fulcrums, thereby fixed contact terminal 41 having a short inter-fulcrum distance and a large rigidity is obtained.

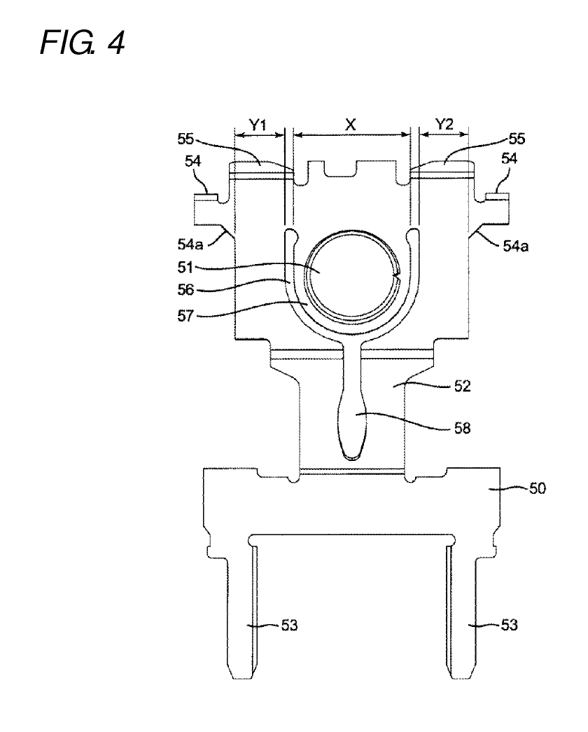

In movable contact terminal 50, as illustrated in FIG. 4, a pair of terminals 53 and 53 extend downward from bent movable touch piece 52 in which movable contact 51 is provided. In movable touch piece 52, position restriction tongue pieces 54 and 54 are provided by cutting and bending edges on both sides in an upper end edge of movable touch piece 52, and retaining tongue pieces 55 and 55 are cut and bent between position restriction tongue pieces 54 and 54 so as to be higher than the surroundings of retaining tongue pieces 55 and 55. In movable touch piece 52, a wide portion which includes cutout groove 56 (such as a curved cutout groove) that is a substantially U-shaped or substantially V-shaped opening formed toward the upper end side of movable touch piece 52. Cutout groove 56 is formed so as to surround turning tongue piece 57 and movable contact 51, which is fixed to turning tongue piece 57 by caulking. Slit 58 communicating with cutout groove 56 is provided on a lower side of movable touch piece 52 in order to adjust a spring constant.

Width X of a base portion of turning tongue piece 57 is larger than a total of widths Y1 and Y2, each width Y1 and Y2 is measured across an edge portion of movable touch pieces 52 located on a side of turning tongue piece 57. Therefore, a spring constant of turning tongue piece 57 is larger than a spring constant of the edge portions on the sides of movable touch piece 52, and when an increasing force is applied to the movable touch piece, the edge portions on the sides of movable touch piece 52 are elastically deformed before turning tongue piece 57 is elastically deformed. At this point, by virtue of C-planes 54a and 54a formed toward the edges on both the sides of movable touch piece 52 at the edge portions on both the sides of position restriction tongue pieces 54 and 54, the edge portions on both the sides of movable touch piece 52 located below C-planes 54a and 54a are easily elastically deformed.

Terminals 53 and 53 are press-fitted in terminal holes 16a and 16a of base 10 (FIG. 3), whereby movable contact 51 is opposed to fixed contact 42 thereby allowing movable contact 51 to come into contact with and separate from fixed contact 42.

In elastic touch piece 60, elastically-curved portion 61 extends outward from the upper end edge, and latching claws 62 and 62 extend laterally from the lower end edge. Latching claws 62 and 62 are inserted in latching holes 14a and 14a formed in the bottom surface of fitting recess 14, whereby elastically-curved portion 61 extends outward from fitting wall 13 to come into press contact with a rear surface of movable contact 51.

Card 70 has a substantial T-shape in planar view. In card 70, a pair of elastic arms 72 and 72 extend in parallel with each other along a narrow end portion 71 so as to be able to be engaged with notches 32 and 32 of movable iron piece 30. In card 70, aligning projections 74 and 74 are projected at edges on both sides of wide end portion 73. Wide end portion 73 engages movable contact terminal 50 between position restriction tongue pieces 54 and retaining tongue pieces 55 of movable contact terminal 50 while a pair of elastic arms 72 and 72 are engaged with notches 32 and 32 of movable iron piece 30.

Box type cover 80 which has an outer shape, is fitted in base 10 and houses components of the electromagnetic relay such as electromagnetic block 20. To complete the assembly work of the electromagnetic relay, box type cover 80 is fitted in base 10, sealing material 81 (FIG. 1B) is injected into the bottom surface of base 10 and on solidification, seals the electromagnetic relay, inner air is sucked and removed through degassing hole 82 (FIG. 1A) of box type cover 80, and degassing hole 82 is heat-sealed.

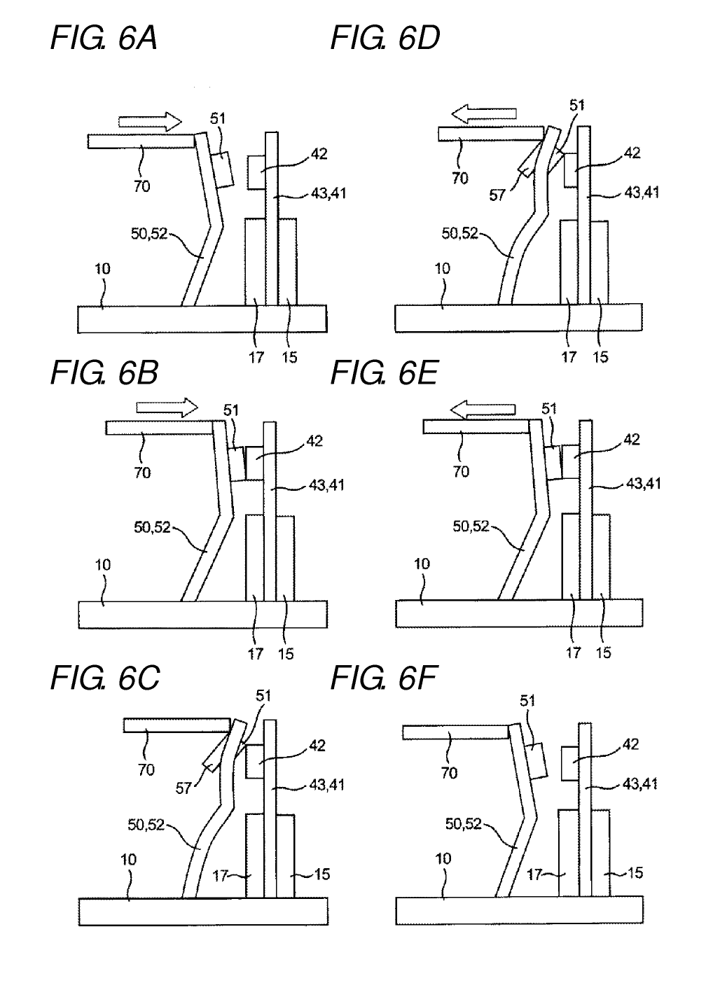

Operation of the electromagnetic relay will be described below with reference to FIGS. 5A to 6F.

In the case that a voltage is not applied to coil 21, movable iron piece 30 is pressed by a spring force of movable touch piece 52 with card 70 interposed between movable touch piece 52 and movable iron piece 30, and movable contact 51 separates from fixed contact 42 and comes into press contact with elastically-curved portion 61 of elastic touch piece 60.

Then, in the case that the voltage is applied to excite coil 21, as illustrated in FIG. 5B, horizontal end portion 30a of movable iron piece 30 is attracted to magnetic pole portion 23b of iron core 23, and movable iron piece 30 turns with perpendicularly lower end portion 25a of yoke 25 as the fulcrum against the spring force of movable touch piece 52. Card 70 pressed by the upper end portion of movable iron piece 30 moves horizontally, and presses the upper end edge of movable touch piece 52. Therefore, movable contact 51 turns to abut on fixed contact 42 (FIG. 6B). When the upper end edge of movable touch piece 52 is further pushed, the edge portions of movable touch piece 52, having the spring constant smaller than that of turning tongue piece 57, are elastically deformed prior to turning tongue piece 57 becoming elastically deformed. Therefore, movable contact 51 is displaced while rolling on the surface of fixed contact 42 (FIG. 6C). Since horizontal end portion 30a of movable iron piece 30 is attracted to magnetic pole portion 23b of iron core 23, as a result, iron core 23, permanent magnet 26, yoke 25, and movable iron piece 30 form a closed magnetic circuit, and an operating state of movable touch piece 52 is retained by a magnetic force from magnetic flux of permanent magnet 26 even if the voltage application to coil 21 is stopped.

As described above, cutout groove 56 includes the opening formed toward the upper end side of movable touch piece 52, and cutout groove 56 is formed so as to surround movable contact 51. Therefore, the force pressing the upper end edge of movable touch piece 52 is efficiently transmitted to movable contact 51 through turning tongue piece 57 by card 70 irrespective of the elastic deformation at the edge portions of movable touch piece 52.

When the voltage is applied to coil 21 in a direction canceling out the magnetic force caused by the magnetic flux of permanent magnet 26, movable iron piece 30 turns in an opposite direction by a magnetic force of coil 21 and the spring force of movable touch piece 52. Therefore, card 70 is drawn back to release the deformation at the edge portions of movable touch piece 52 as illustrated in FIG. 6D, turning tongue piece 57 turns in the opposite direction, and movable contact 51 rolls on the surface of fixed contact 42 (FIG. 6E) and the contact between movable contact 51 and fixed contact 42 is opened (FIG. 6F). Movable contact 51 comes into press contact with elastically-curved portion 61 of elastic touch piece 60 to absorb and release a rapid returning force of movable contact 51, and movable contact 51 is returned to an original position.

At this point, magnetic leakage is not generated because permanent magnet 26, auxiliary yoke 24, and yoke 25 form the magnetic circuit. As a result, even if movable iron piece 30 turns due to the external vibration, horizontal end portion 30a of movable iron piece 30 is not attracted to magnetic pole portion 23b of iron core 23, and there is no malfunction. Accordingly, high-reliability in the electromagnetic relay is achieved.

In the embodiment, movable contact 51 is displaced so as to roll on the surface of the fixed contact. Even if movable contact 51 is welded to fixed contact 42, welded movable contact 51 is separated from fixed contact 42 by not a tensile force but a shearing force, so that the welded movable contact can forcedly be separated from the fixed contact by a small opening force.

Because fixed contact terminal 41 turns with aligning projections 44 provided in fixed touch piece 43 as the fulcrums, the inter-fulcrum distance is short and the rigidity is large. Therefore, the contact is further easily opened.

In accordance with one aspect of an embodiment of the present invention, the movable contact rolls on the surface of the fixed contact when the turning tongue piece turns, hence one-sided contact of the movable contact at the pinpoint is eliminated and even if a large amount of current is passed, the movable contact and the fixed contact are not abraded and contact lifetimes are lengthened.

Since the movable contact rolls on the surface of the fixed contact, a shearing force and not a tensile force acts between the movable contact and the fixed contact. Therefore, if the movable contact is welded to the fixed contact, the welded movable contact can forcedly be separated from the fixed contact by a small opening force and a high-reliability contact mechanism is obtained.

In the contact mechanism, because the cutout groove may include an opening formed toward an upper end side of the movable touch piece, and the cutout groove may be formed so as to surround the movable contact, the force pressing on the upper end edge of the movable touch piece is efficiently transmitted to the movable contact by the operation member. Additionally, the movable contact rolls on the surface of the fixed contact because the turning tongue piece turns as the movable touch piece comes into operation or returns to an original position.

In accordance with an aspect of an embodiment of the present invention, a shape of the cutout groove is selected based on requirements of the application. Therefore, greater flexibility in designing of the contact mechanism is achieved.

In accordance with an aspect of an embodiment of the present invention, both sides of the turning tongue piece include the movable touch piece, and a spring constant of the turning tongue piece may be larger than spring constants of edge portions of the movable touch piece.

Accordingly, because the edge portions on both the sides of the turning tongue piece are easily elastically deformed compared with the turning tongue piece, the turning tongue piece turns without the elastic deformation, and the movable contact rolls easily on the surface of the fixed contact.

In an aspect of an embodiment of the present invention, the width of the base portion of the turning tongue piece may be larger than a total of the two widths, each width is measured across the edge portion of the movable touch piece located at the side of the turning tongue piece.

Accordingly, because the edge portions on both the sides of the turning tongue piece are harder easily elastically deformed compared with the turning tongue piece, the turning tongue piece turns without elastic deformation, and the movable contact rolls more easily on the surface of the fixed contact.

In accordance with an aspect of an embodiment of the present invention, a slit communicating with the cutout groove may extend downward in the movable touch piece.

Accordingly, the spring constant of the movable touch piece is easily adjusted and an easy-to-design movable touch piece is obtained.

In accordance with an aspect of an embodiment of the present invention, the fixed touch piece may be held in the base such that the turning fulcrum of the fixed touch piece is located above the turning fulcrum of the movable touch piece.

Accordingly, the fixed touch piece is more rigid than the movable touch piece, and hence the movable contact will roll more easily on the fixed contact.

### INDUSTRIAL APPLICABILITY

The contact mechanism of the present invention can be applied to not only the self-holding electromagnetic relay, but also other electromagnetic relays such as a self-returning electromagnetic relay.

What is claimed is:

1. A contact mechanism comprising:
a base;
a movable touch piece that comprises a movable contact and stands in the base;
a fixed touch piece that comprises a fixed contact and stands in the base; and
an operation member configured to move reciprocally in a direction; wherein
the movable contact is opposed to the fixed contact and configured to come into contact with and separate from the fixed contact, the operation member configured to move reciprocally in a direction to press and release an upper end edge of the movable touch piece, and the movable touch piece is configured to turn to cause the movable contact to come into contact with and separate from the fixed contact, and
the movable contact is fixed to a turning tongue piece that is formed by providing a cutout groove in the movable touch piece.

2. The contact mechanism according to claim 1, wherein the cutout groove comprises an opening formed toward an upper end side of the movable touch piece, and the cutout groove is formed so as to surround the movable contact.

3. The contact mechanism according to claim 1, wherein the cutout groove is a U-shaped opening.

4. The contact mechanism according to claim 1, wherein the cutout groove is a V-shaped opening.

5. The contact mechanism according to claim 1, wherein a spring constant of the turning tongue piece is larger than a spring constant of edge portions of the movable touch piece located on both sides of the turning tongue piece.

6. The contact mechanism according to claim 1, wherein a width of a base portion of the turning tongue piece is larger than a total of a width of an edge portion of the movable touch piece located at a left side of the turning tongue piece and a width of an edge portion of the movable touch piece located at a right side of the turning tongue piece.

7. The contact mechanism according to claim 1, wherein a slit communicating with the cutout groove extends downward in the movable touch piece.

8. The contact mechanism according to claim 1, wherein the fixed touch piece is held in the base such that a turning fulcrum of the fixed touch piece is located above a turning fulcrum of the movable touch piece.

9. The contact mechanism according to claim 2, wherein the cutout groove is a U-shaped opening.

10. The contact mechanism according to claim 2, wherein the cutout groove is a V-shaped opening.

11. The contact mechanism according to claim 2, wherein a spring constant of the turning tongue piece is larger than a spring constant of edge portions of the movable touch piece located on both sides of the turning tongue piece.

12. The contact mechanism according to claim 2, wherein a width of a base portion of the turning tongue piece is larger than a total of a width of an edge portion of the movable touch piece located at a left side of the turning tongue piece and a width of an edge portion of the movable touch piece located at a right side of the turning tongue piece.

13. The contact mechanism according to claim 2, wherein a slit communicating with the cutout groove extends downward in the movable touch piece.

14. The contact mechanism according to claim 2, wherein the fixed touch piece is held in the base such that a turning fulcrum of the fixed touch piece is located above a turning fulcrum of the movable touch piece.

15. The contact mechanism according to claim 8, wherein the cutout groove is a U-shaped opening.

16. The contact mechanism according to claim 8, wherein the cutout groove is a V-shaped opening.

17. The contact mechanism according to claim 8, wherein a spring constant of the turning tongue piece is larger than a spring constant of edge portions of the movable touch piece located on both sides of the turning tongue piece.

18. The contact mechanism according to claim 8, wherein a width of a base portion of the turning tongue piece is larger than a total of a width of an edge portion of the movable touch piece located at a left side of the turning tongue piece and a width of an edge portion of the movable touch piece located at a right side of the turning tongue piece.

19. The contact mechanism according to claim 8, wherein a slit communicating with the cutout groove extends downward in the movable touch piece.

20. An electromagnetic relay comprising:
the contact mechanism according to claim 1.
